(19) United States
(12) Patent Application Publication
(10) Pub. No.: US 2011/0014584 A1
(43) Pub. Date: Jan. 20, 2011

(54) ORAL HYGIENE DEVICE AND METHOD THEREOF

(75) Inventor: Michael S. Lesser, Green Brook, NJ (US)

Correspondence Address: MALDJIAN & FALLON LLC, 36 BINGHAM AVENUE, RUMSON, NJ, 07760, US

(73) Assignee: Revive Personal Products, Madison, NJ (US)

(21) Appl. No.: 12/504,737

(22) Filed: Jul. 17, 2009

(51) Int. Cl. A61C 3/06; A61C 17/00

(52) U.S. Cl. 433/142; 433/216

(57) ABSTRACT

Embodiments of the present invention relate to an oral hygiene device for use in cleaning the teeth as well as the interproximal spaces between the teeth, and methods of manufacturing and using same. In accordance with one embodiment of the present invention, an oral hygiene device comprises a substantially rigid member having a dental cleaner on a first end and an interdental cleaner substantially terminating in an apex on a second end, the substantially rigid member being substantially free of filaments and bristles, and a coating material disposed on an outer surface of the dental cleaner, the coating material comprising at least an abradant.

### BACKGROUND

1. Field of the Invention

Embodiments of the present invention generally relate to an oral hygiene device and method thereof. More specifically, embodiments of the present invention relate to an oral hygiene device for use in cleaning the teeth as well as the interproximal spaces between the teeth, and methods of manufacturing and using same.

2. Description of the Related Art

With great advancement being rapidly made in the fields of dentistry and orthodontic technology, more and more instruments and products designed for maintaining proper oral and dental hygienic habits appear in the marketplace each day. Many devices have appeared on the market that are designed to clean the interproximal spaces between the teeth. Specifically, a number of devices comprising hand-manipulable picks and points are currently available, as well as dental floss comprising a variety of improvements and innovations over its basic structure, which was conceived in the nineteenth century. However, the market has seen few improvements in dental cleaners since the advent of the toothbrush.

Known devices have included dental instruments containing a plurality of flexible bristles or filamentary members, which protrude generally outward from a hand-manipulable handle. In some instances, the bristles of these instruments may be coated or impregnated with an abrasive material. Other known devices comprise a hand-manipulable instrument having a pick on one side and a set of flexible bristles or filamentary members on the opposite side of a rigid member. However, it is well known that devices having brushes or brush-like filaments are not effective in removing stains from the teeth, such as those left behind by coffee, red wine, and cigarette smoking. As such, even after vigorous brushing and scrubbing with a bristled object, the user's teeth will still be significantly discolored as a result of the continued presence of the discoloring substances.

Thus, there is a need for an improved oral hygiene device and method thereof.

### SUMMARY

Embodiments of the present invention relate to an oral hygiene device for use in cleaning the teeth as well as the interproximal spaces between the teeth, and methods of manufacturing and using same. In accordance with one embodiment of the present invention, an oral hygiene device comprises a substantially rigid member having a dental cleaner on a first end and an interdental cleaner substantially terminating in an apex on a second end, the substantially rigid member being substantially free of filaments and bristles, and a coating material disposed on an outer surface of the dental cleaner, the coating material comprising at least an abradant.

In accordance with another embodiment of the present invention, an oral hygiene device comprises a substantially rigid member having a cleaning surface on a first end and an interdental cleaner on a second end, the substantially rigid member being substantially free of filaments and bristles; and a coating material disposed on an outer surface of the cleaning surface, the coating material comprising a combination of any of an abradant, a whitening agent, a foaming agent, and a flavorant; wherein the cleaning surface is substantially perpendicular to an axis extending between the first end and the second end; and wherein the interdental cleaner comprises a plurality of tapered surfaces terminating in an apex.

In accordance with yet another embodiment of the present invention, a method of cleaning an oral cavity comprises providing an oral hygiene device comprising a substantially rigid member having a dental cleaner on a first end and an interdental cleaner on a second end, the substantially rigid member being substantially free of filaments and bristles; and a coating material disposed on an outer surface of the dental cleaner, the coating material comprising at least an abradant; wherein the interdental cleaner comprises a plurality of tapered surfaces terminating in an apex; placing the coating material of the dental cleaner of the oral hygiene device in contact with a tooth for removing stains from the surface of the tooth; and imparting motion to the oral hygiene device along the plane of at least a surface of the tooth; whereby the dental cleaner substantially removes stains from the surface of the tooth.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1a depicts a side view of an oral hygiene device in accordance with one embodiment of the present invention;

FIG. 1b depicts a perspective view of the oral hygiene device of FIG. 1a;

FIG. 1c depicts a back view of the oral hygiene device of FIG. 1a;

FIG. 1d depicts a front view of the oral hygiene device of FIG. 1a;

FIG. 2 depicts an oral hygiene device in accordance with one embodiment of the present invention;

FIG. 3 depicts an oral hygiene device in accordance with one embodiment of the present invention;

FIG. 4 depicts an oral hygiene device in accordance with one embodiment of the present invention;

FIG. 5 depicts an oral hygiene device in operation in accordance with one embodiment of the present invention;

FIG. 6 depicts an oral hygiene device in operation in accordance with one embodiment of the present invention; and

FIG. 7 depicts a flowchart of a method of cleaning an oral cavity in accordance with yet another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present invention generally relate to an oral hygiene device and method thereof. More specifically, embodiments of the present invention relate to an oral hygiene device for use in cleaning and/or whitening the surfaces of the teeth as well as the interproximal spaces (between the teeth), massaging the tissue within the oral cavity, and methods of manufacturing and using same.

As used herein, the terms “tooth” and “teeth” and any derivative terms thereof may refer to a tooth or prosthesis therefor, such as a crown or a denture. As used herein, the term “interproximal space” and any derivative terms thereof may refer to a space between two or more teeth, including the surfaces of the teeth bounding the space. As used herein, the term “whitening agent” and any derivative terms thereof may refer to a bleaching agent, a white dying agent, or any other substance which, when applied to a tooth, gives the appearance of being substantially white. The term may also include agents that remove discolorations on the tooth, as well as agents that cover up discolorations with a substantially white substance. As used herein, the term “white” and any derivative terms thereof should be construed to include “substantially white.” As used herein, the term “gripping portion” and any derivative terms thereof may refer to a device or portion that facilitates manual manipulation of the oral hygiene device. Such a gripping portion may include bumps, ridges, indentations, any other pattern or texture feasible in the context of the present invention, or any combination thereof, generally in relation to a portion of the surface area of a rigid member.

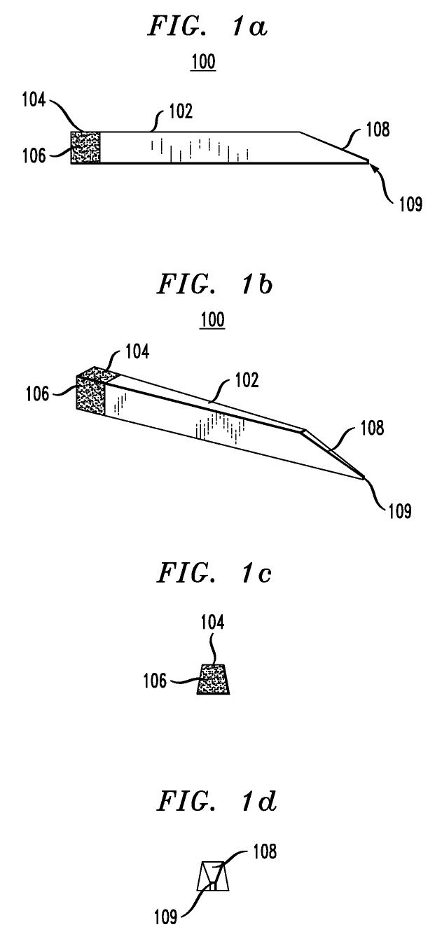

Referring now to FIGS. 1a, 1b, 1c, and 1d, an oral hygiene device 100 in accordance with one or more embodiments of the present invention comprises a substantially rigid member 102. The substantially rigid member 102 generally comprises a dental cleaner 104 on a first end and an interdental cleaner 108 on a second end. In many embodiments, the oral hygiene device 100, including the substantially rigid member 102, the dental cleaner 104 and the interdental cleaner 108 are free from filaments and bristles extending therefrom or passing therethrough.

The substantially rigid member 102 may comprise any number of materials or combinations thereof, including but not limited to wood, re-engineered wood, polymeric materials (e.g., low-density polyethylene, high-density polyethylene, polypropylene, polymethyl methacrylate, polyethylene terephthalate, polystyrene), glass, ceramic, metal (e.g., aluminum, iron, titanium, nickel, cobalt, chromium, magnesium, copper, zinc, silver, zirconium, gold, palladium, platinum, molybdenum, tin), metal alloys (e.g., brass, carbon steel, electrum, stainless steel, pewter), rubbers or general synthetic materials, combinations thereof, or the like.

The substantially rigid member 102 may take any shape feasible for embodiments of the present invention. For example, the cross-section of the substantially rigid member 102 may take the shape of a polygon or geometric shape (e.g., triangle, rectangle, square, circle, oval, trapezoid, parallelogram, star, etc.) or the shape of a character or symbol (e.g., Superman® symbol, Batman® symbol, “X”, any letter or number, or the like), or any other suitable shape serving both aesthetic and functional purposes as set forth herein. Additionally, the cross-section of the substantially rigid member 102 may be variable throughout the length and/or the width of the member 102.

The dental cleaner 104 may comprise at least a back surface of the substantially rigid member, at least operable to clean a surface of an individual's tooth. For many embodiments of the present invention, the dental cleaner 104 is described as a portion of an end of the substantially rigid member 102, comprising at least the back surface of the substantially rigid member 102. In many embodiments, the back surface of the substantially rigid member 102 is substantially perpendicular to an axis extending through the substantially rigid member 102 from a first end to a second end of the oral hygiene device 100.

In accordance with embodiments of the present invention, a coating material 106 is disposed on at least a substantial portion of an outer surface of the dental cleaner 104 of the oral hygiene device 100. Such coating material 106 may comprise at least an abradant material. An abradant in accordance with embodiments of the present invention may comprise a granulated material, which may be utilized in connection with removing unwanted material from the surface of a tooth. By way of example, an abradant may comprise any one or more of diatomaceous earth, mica, silica, alumina, calcium carbonate, calcium phosphate, or any other abradant material feasible in embodiments of the present invention.

The coating material 106 may further comprise additional substances, such as any one or more of a whitening agent, baking soda, a foaming agent, a flavorant, and an odorant. Any one or more of these substances may be present in the coating material 106 in any proportion and in any amount. Such substances may be utilized in connection with enhancing the user's experience with the oral hygiene device 100 and providing a functional cleaning action when the oral hygiene device 100 is in operation.

In accordance with one or more embodiments of the present invention, a whitening agent may comprise a substance or mixture, such as a bleaching agent, baking soda, a white dying agent, or any other substance which, when applied to a tooth, gives the appearance of being substantially white. A whitening agent, such as dental bleach, may be utilized in connection with removing stains from a tooth or plurality of teeth; alternatively, a whitening agent, such as a white dye, pigment, or colorant, may be utilized in connection with covering up stains on a tooth or a plurality of teeth.

A foaming agent in accordance with one or more embodiments of the present invention may comprise a substance or mixture that facilitates the formation of foam. Such foaming agents may include sodium lauryl sulfate (SLS), any derivative compound thereof (e.g., sodium laureth sulfate (SLES), ammonium lauryl sulfate (ALS), etc.), any other foaming agent feasible in the context of the present invention, and any combination thereof. As understood by embodiments of the present invention, many of foaming agents are activated by saliva or liquid in the mouth of a user, and as such, may be provided in a powder, solid, liquid or capsulated form.

Flavorants and odorants may additionally be added to the coating material 106. In accordance with one embodiment of the present invention, a single substance or mixture may act as both a flavorant and an odorant (e.g., peppermint oil, spearmint oil, or the like.). Flavorants may comprise any substance or mixture that imparts flavor to the coating material 106, including but not limited to peppermint oil, spearmint oil, tea tree oil, any fruit juices and/or extracts, sugar, corn syrup, any other flavorant feasible in the context of the present invention, and any combination thereof. Odorants impart a smell or scent to the coating material 106, and may include volatile organics (e.g., esters, ethers, alcohols, aldehydes, ketones, terpenes, lactones, and the like).

The interdental cleaner 108 generally comprises a plurality of tapered surfaces substantially terminating in an apex 109. The unique design of the interdental cleaner 108 of the oral hygiene device 100 allows the interdental cleaner 108 to effectively clean out the interproximal spaces in the oral cavity. At the same time, the interdental cleaner 108 may also be used to massage the tissue (e.g., gums) of the oral cavity.

The apex 109 of the interdental cleaner 108 may be pointed, as a needle, or may comprise a surface having a minimal surface area, formed from the convergence of any number of a multitude of side surfaces. As shown in FIG. 1d, a front view of an oral hygiene device 100 in accordance with one embodiment of the present invention may comprise a substantially planar or curved surface at the apex 109 of the plurality of tapered surface. Such an embodiment of the oral hygiene device 100 of the present invention may provide the user with an oral hygiene device 100 which carries with it less potential to inflict serious damage to a user's gingival papilla and teeth. In an alternative embodiment, the interdental cleaner 108 may comprise a rubber-based needle or tip-like structure. In such an embodiment, the rubber-based tip may be either a coating over the substantially rigid member 102, or may be integrally formed with the substantially rigid member 102 itself.

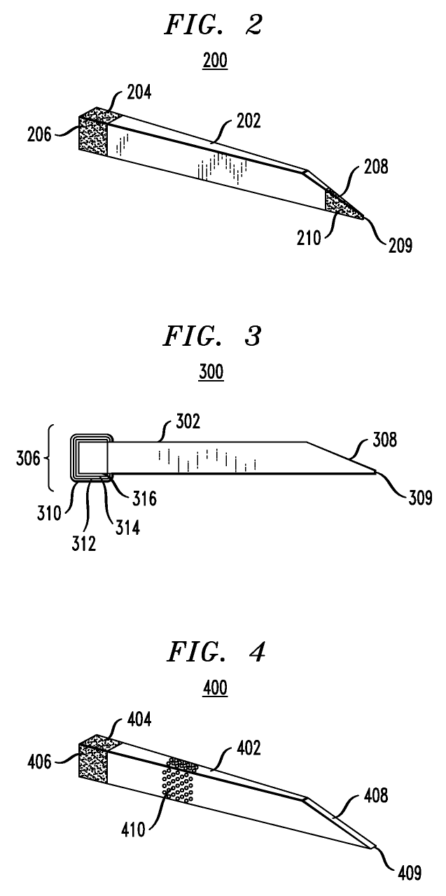

Referring now to FIG. 2, in accordance with another embodiment of the present invention, the interdental cleaner 208 of an oral hygiene device 200 may be coated with a second coating material 210. This second coating material 210 may be substantially identical or similar to, or substantially different than the coating material 206 disposed on the dental cleaner 204 of the oral hygiene device 200. Such second coating material 210 may comprise any one or more of an abradant, a whitening agent, a foaming agent, a flavorant, and an odorant. These components may be substantially identical or similar to, or substantially different than those components in the coating material 206 of the dental cleaner 204. To clarify, as appreciated by embodiments of the present invention, the interdental cleaner 208 may comprise a second coating material 210 being a selected material (e.g., abradant, whitening agent, or the like), and the dental cleaner 204 may comprise a first coating material 206 being different from the first material, but similarly related (e.g., where the second coating material 210 comprises an abradant, a first coating material 206 may comprise a whitening agent, or the like.)

It should be noted the coating material 206 of the dental cleaner 204 and the second coating material 210 disposed on the interdental cleaner 208 may be disposed on their respective ends in any amounts and any dimensions, and amounts and/or dimensions of each may be substantially identical, similar, or different relative to the other. Additionally, these amounts and dimensions may be substantially fixed or variable at each end—that is to say, e.g., the thickness of the coating material 206 at the dental cleaner 204 may be substantially the same all around (e.g., 1/16 inch all around) or substantially variable (e.g., starting at 1/16 inch at the surface and tapering outwards to ⅛ inch at 10% of the way up the length of the substantially rigid member 202).

The coating material and the second coating material of the oral hygiene device need not be homogeneous. As depicted in the exemplary embodiment of FIG. 3, a coating material 306 in accordance with one embodiment of the present invention may be separated into strata (depicted in FIG. 3 as four layers, labeled 310, 312, 314, 316), each stratum comprising one or more of the components of the coating material 306. In one such an embodiment, the coating material 306 may comprise a thin or quick-dissolving layer of a flavorant, which layer, in operation, disintegrates rapidly and gives way to a layer of abradant material. Although four layers are depicted in the embodiment shown in FIG. 3, embodiments of the present invention contemplates any number of layers being disposed in such a fashion about one or more ends of the substantially rigid member 302.

In accordance with another embodiment of the present invention, an oral hygiene device 400 may comprise a rigid member 402 having a gripping portion 410. The gripping portion 410 may comprise bumps, ridges, indentations, any other pattern feasible in the context of the present invention, or any combination thereof. The gripping portion 410 of the oral hygiene device 400 may be utilized by a user to facilitate hand manipulability of the oral hygiene device 400, for example, when utilizing the dental cleaner 404 (in connection with the coating material 406) or the interdental cleaner 408. It should be noted the gripping portion 410 may be disposed on any portion of the substantially rigid member 402 and about any length of the substantially rigid member 402 without departing from the scope of embodiments of the present invention.

In certain embodiments of the present invention, the gripping portion 410 may be utilized as a gum massager or similar tool. For example, in one embodiment, the gripping portion 410 may be provided with small ridges and bumps to stimulate a user's mouth, and the tissue therein, when moved along the tissue in an ordinary fashion. In another embodiment, where a gripping portion 410 is provided integral with either the dental cleaner 404 or the interdental cleaner 408, the entire end of the substantially rigid member 402 may be constructed as a gum massager, inclusive with any coatings on the respective end of the substantially rigid member.

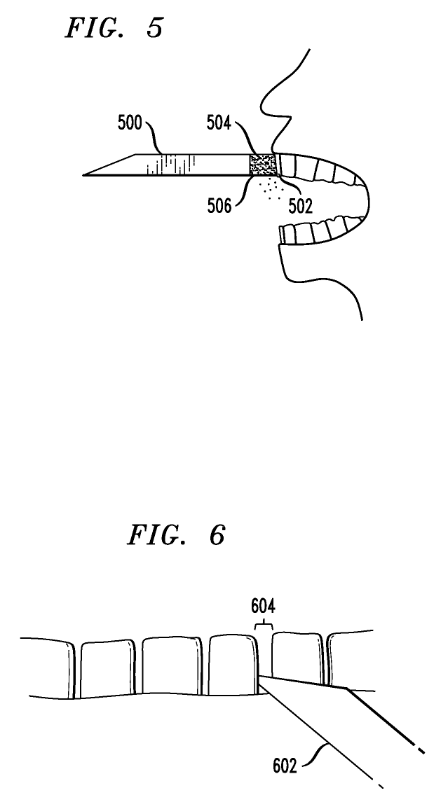

FIG. 5 depicts an oral hygiene device 500 in operation on a user's tooth 502 in accordance with one embodiment of the present invention. An oral hygiene device 500 is depicted in this figure configured such that the coating material 504 of the dental cleaner 506 is in contact with a tooth 502. In another embodiment, FIG. 6 depicts the interdental cleaner 602 of an oral hygiene device in operation in an interproximal space 604 of an oral cavity. The interdental cleaner 602 may be inserted in an interproximal space 604 in order to remove food particles and bacteria that may have been lodged between the teeth. The interdental cleaner 602 may also be used to massage the tissue in the oral cavity. Additionally, an oral hygiene device such as that depicted in FIG. 2, i.e., an embodiment in which a second coating material 210 is disposed on an outer surface of the interdental cleaner 208, may be utilized as a stain remover, abrading a portion of the smaller surfaces of the teeth in order to remove stained material.

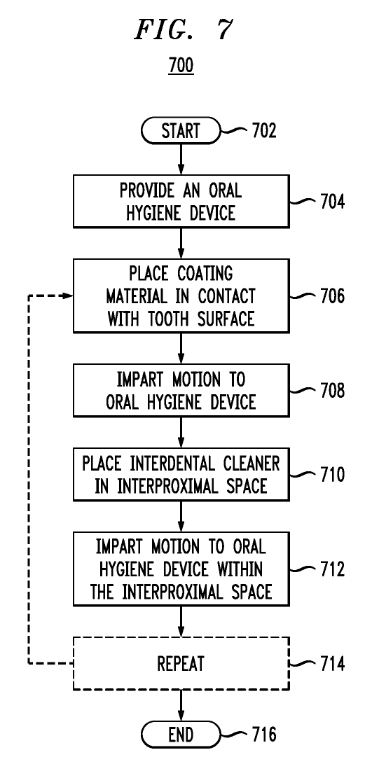

In order to make use of the oral hygiene device of the present invention, a method 700 is disclosed for use in cleaning an oral cavity, as depicted in FIG. 7. A method 700 for cleaning an oral cavity begins at step 702. At step 704, an oral hygiene device is provided. Such an oral hygiene device may comprise an oral hygiene device in accordance with any embodiment of the present invention herein described, either expressly or inherently, or otherwise contemplated. For example, in one embodiment, an oral hygiene device comprises a substantially rigid member having a dental cleaner on a first end and an interdental cleaner on a second end, the substantially rigid member being substantially free of filaments and bristles; and a coating material disposed on an outer surface of the dental cleaner; wherein the interdental cleaner comprises a plurality of tapered surfaces terminating in an apex.

At step 706, the coating material of the oral hygiene device is placed in contact with the surface of a tooth. The coating material may comprise any substances herein described. In one embodiment, the coating material comprises one or more of an abradant, a colorant, a whitening agent, a foaming agent, a flavorant, an odorant, or any combination thereof.

At step 708, the user imparts motion to the oral hygiene device. Such motion typically comprises motion having a nonzero magnitude component along the plane of the surface of the tooth. In such a manner, the coating material acts upon the surface of the tooth. In accordance with one embodiment of the present invention, this motion allows the abradant material of the coating material to abrade the tooth, thus removing at least a portion of any stain material or stained material which may be present on the tooth. Such motion may activate a foaming agent that may be present in the coating material, which may then begin to cause a foam to be formed in the oral cavity. Further still, such motion may apply a whitening agent that may be present in the coating material, which may act either to bleach the tooth, or to apply a white pigment or other colorant to the tooth in order to cover up any stain.

In accordance with another embodiment of the present invention, utilizing this motion in connection with an oral hygiene device comprising a layered coating material, such as that described above, may serve to move and expose layers. By way of example, an oral hygiene device may comprise a coating material having a layer of an abradant material closest to the surface of the substantially rigid member, followed by a layer of a foaming agent disposed on the layer of an abradant material, followed by a layer of a flavorant/odorant disposed on the layer of a foaming agent, without departing from the scope of the present disclosure. When the above-described motion is imparted to such an oral hygiene device, the layer of a flavorant/odorant may be dispensed onto the tooth, presenting the user with a taste and/or smell, and thus giving way to the foaming agent. Continued motion would allow the foaming agent to create a foam in the mouth, and would further give way to the abradant material, and such motion would subsequently allow the abradant to abrade stains and stained material off of the tooth.

At step 710, the user inserts the interdental cleaner portion of an oral hygiene device in accordance with one embodiment of the present invention into an interproximal space of an oral cavity. In such a manner, the user places the oral hygiene device in a configuration which is effective to clean out an interproximal space of the oral cavity and/or massage the tissue within the oral cavity.

At step 712, the user imparts motion to the oral hygiene device while the interdental cleaner portion of the oral hygiene device is disposed within an interproximal space. Such motion may be in any particular direction or directions or along any plane or plurality thereof. Such motion allows the oral hygiene device to remove any food particles, bacteria, or any other foreign material present, from the interproximal space. In many embodiments, the motion of the oral hygiene device allows the interdental cleaner to additionally remove stains and stained material from the smaller surfaces of the teeth bounding the interproximal space.

At optional step 714, the method 700 may return to step 706 and repeat the subsequent steps. It should be noted, however, many embodiments of the present invention are disposable and are intended as “one-time” use products. It should be appreciated by embodiments of the present invention, “one-time” use should refer to use during one cleaning session (i.e., a single continuous use of the product), and does not include consecutive or subsequent cleaning sessions. The method 700 ends at steps 716.

In accordance with alternative embodiments of the present invention, the oral hygiene device may be utilized with any number of combination of the features disclosed herein, and may also be utilized in a slightly alternative manner to achieve more than just a beneficial oral hygiene result. For example, in certain embodiments, the structure of the oral hygiene device may be modified as an oral medication applicator. In such an embodiment, the oral hygiene device may be provided with any number of “coatings,” over a first or second end of the device, wherein the coatings comprise any number of oral medications. Such oral medications may include: an anti-bacterial, anti-viral, or anti-fungal solution; an analgesic or pain suppressant; a dosage of prescribed topical oral medicine requiring direct application, or the like.

It should be emphasized that the above-described embodiments of the present invention are merely possible examples of implementations, merely set forth for a clear understanding of the principles of the invention. Many variations and modifications may be made to the above-described embodiments) of the invention without departing substantially from the spirit and principles of the invention. All such modifications and variations are intended to be included herein within the scope of this disclosure and the present invention and protected by the following claims.

What is claimed is:

1. An oral hygiene device comprising:
a substantially rigid member having a dental cleaner on a first end and an interdental cleaner substantially terminating in an apex on a second end, the substantially rigid member being substantially free of filaments and bristles; and
a coating material disposed on an outer surface of the dental cleaner, the coating material comprising at least an abradant.

2. The oral hygiene device of claim 1, wherein the dental cleaner is disposed about at least a surface of the oral hygiene device, the surface being substantially perpendicular to an axis extending between the first end and the second end.

3. The oral hygiene device of claim 1, wherein the coating material further comprises at least one of a whitening agent, a foaming agent, a flavorant, or an odorant.

4. The oral hygiene device of claim 1, wherein the abradant of the coating material comprises at least one of diatomaceous earth, mica, silica, alumina, calcium carbonate, or calcium phosphate.

5. The oral hygiene device of claim 1, wherein the interdental cleaner comprises at least one of a substantially planar surface or a curved surface.

6. The oral hygiene device of claim 1, further comprising:
a second coating material disposed on an outer surface of the interdental cleaner.

7. The oral hygiene device of claim 6, wherein the coating material disposed on an outer surface of the dental cleaner and the second coating material disposed on an outer surface of the interdental cleaner comprise substantially identical compositions.

8. The oral hygiene device of claim 6, wherein the second coating material further comprises at least one of an abradant, a whitening agent, a foaming agent, a flavorant, or an odorant.

9. The oral hygiene device of claim 1, wherein the substantially rigid member comprises a variably-shaped cross-section along a length of the substantially rigid member.

10. The oral hygiene device of claim 1, wherein the substantially rigid member further comprises a gripping portion disposed thereon or integral therewith.

11. The oral hygiene device of claim 1, wherein the substantially rigid member comprises at least one of wood, rubber, a polymeric material, ceramic, glass, or metal.

12. An oral hygiene device for removing stains comprising:
a substantially rigid member having a cleaning surface on a first end and an interdental cleaner having a plurality of tapered surfaces terminating in an apex on a second end, the substantially rigid member being substantially free of filaments and bristles; and
a coating material disposed on an outer surface of the cleaning surface, the coating material comprising at least one of an abradant, a whitening agent, a foaming agent, or a flavorant;
wherein the cleaning surface is substantially perpendicular to an axis extending between the first end and the second end.

13. The oral hygiene device of claim 12, wherein the abradant of the coating material comprises at least one of diatomaceous earth, mica, silica, alumina, calcium carbonate, or calcium phosphate.

14. The oral hygiene device of claim 12, further comprising:
a second coating material disposed on an outer surface of the interdental cleaner, the second coating material comprising at least one of an abradant, a whitening agent, a foaming agent, a flavorant, or an odorant.

15. The oral hygiene device of claim 14, wherein the coating material disposed on an outer surface of the cleaning surface and the second coating material disposed on an outer surface of the interdental cleaner are substantially similar.

16. A method of cleaning an oral cavity comprising:
providing an oral hygiene device comprising:
a substantially rigid member having a dental cleaner on a first end and an interdental cleaner on a second end, the substantially rigid member being substantially free of filaments and bristles; and
a coating material disposed on an outer surface of the dental cleaner, the coating material comprising at least an abradant;
wherein the interdental cleaner comprises a plurality of tapered surfaces substantially terminating in an apex;
placing the coating material of the dental cleaner of the oral hygiene device in contact with a tooth for removing stains from the surface of the tooth; and
imparting motion to the oral hygiene device along the plane of at least a surface of the tooth;
whereby the dental cleaner substantially removes stains from the surface of the tooth.

17. The method of claim 16, further comprising:
placing the interdental cleaner of the oral hygiene device in an interproximal space between a set of teeth; and
imparting motion to the oral hygiene device within the interproximal space.

18. The method of claim 16, wherein the coating material further comprises at least one of a whitening agent, a foaming agent, a flavorant, or an odorant.

19. The method of claim 16, wherein the abradant of the coating material of the oral hygiene device comprises at least one of diatomaceous earth, mica, silica, alumina, calcium carbonate, or calcium phosphate.

20. The method of claim 16, wherein the oral hygiene device further comprises:
a second coating material disposed on an outer surface of the interdental cleaner, the second coating material comprising at least one of an abradant, a whitening agent, a foaming agent, a flavorant, or an odorant.
